(19) United States
(12) Patent Application Publication
(10) Pub. No.: US 2010/0248594 A1
(43) Pub. Date: Sep. 30, 2010

(54) SETUP TOOL FOR GRINDER SHARPENING JIGS

(76) Inventor: Darrel Nish, Provo, UT (US)

Correspondence Address: BATEMAN IP LAW GROUP, P.O. BOX 1319, SALT LAKE CITY, UT, 84110, US

(21) Appl. No.: 12/708,428

(22) Filed: Feb. 18, 2010

Related U.S. Application Data
(60) Provisional application No. 61/165,473, filed on Mar. 31, 2009.

(51) Int. Cl. B24B 41/06; B24B 3/34; B24B 49/00; G01B 1/00

(52) U.S. Cl. 451/48; 451/371; 451/369; 33/640

(57) ABSTRACT

A tool for setting the grind angle for sharpening jigs accurately and repeatably positions a movable support arm so that a consistent angle is ground into chisels regardless of the grinding wheel diameter and particular chisel.

### PRIORITY

The present application claims the benefit of U.S. Provisional Application Ser. No. 61/165,473, filed Mar. 31, 2009, which is herein incorporated by reference in its entirety.

### THE FIELD OF THE INVENTION

The present invention relates to sharpening jigs for grinders. More specifically, the present invention relates to a tool or gauge for properly positioning a sharpening jig to achieve an accurate and consistent angle while sharpening woodworking tools.

### BACKGROUND

Woodworking tools such as chisels are commonly used for recreational use as well as commercial production. In the case of wood turning (using a wood lathe), the tools include gouges, skew chisels, and the like. These as well as other tools must be periodically sharpened in order for the tool to perform as intended. As the gouges and skew chisels are relatively difficult to sharpen by hand, grinding jigs have been made which hold the tool and position the tool against a grinding wheel for sharpening.

Turning now to FIG. 1, an exemplary prior art sharpening jig 10 for sharpening chisels such as woodturning chisels is shown. The jig 10 is used in combination with a bench grinder 14. The grinder 14 includes a motor, base 22, grinding wheel 26, and guard 30. The jig 10 includes both a tool holder and a support structure. The jig support structure is mounted to the grinder 14 or the bench to which the grinder is mounted so that the jig support arm 18 is level with the bottom of the grinder base 22. The jig support arm 18 includes an extendible arm portion 34 with a cup 38 or saddle on the end thereof.

The jig 10 also includes a tool holder 42 which has a tool mounting block 46 and a support post 50. In use, several steps are required to properly grind a chisel 58. The extendible portion of the support arm 34 is moved to place the cup 38 a predetermined distance in front of the grinding wheel 26 and locked in place with a thumb screw 54. A chisel 58 is locked into the mounting block 46 to extend from the mounting block 46 a predetermined distance. The tool mounting block 46 is locked at an angle relative to the support post 50 with a thumb screw 62. The angle between the tool mounting block 46 and the support post 50 (and as such the angle between the chisel 58 and the support post 50) is varied in order to vary the angle at which the chisel 58 is sharpened. Finally, the tip of the chisel 58 is sharpened against the grinding wheel.

The sharpening jigs 10, while useful, have several limitations. The primary limitation of available sharpening jigs 10 is the inability of the user to properly and repeatably set up the jig. Available grinding jigs 10 require the user to adjust the overhang of the tool extending out from the mounting block 46, the angle of the mounting 46 block relative to the tool post 50, and the position of the support arm 34 in order to properly select the angle at which the chisel is sharpened. All of these adjustments limit the accuracy and repeatability with which a user can set up the grinding jig 10 and thus limit the ability of the user to accurately and repeatably sharpen a chisel 58.

A significant obstacle in setting up a prior art grinding jig 10 is that the user is not able to set the position of the extendible support arm 34 properly. This position must be set periodically to account for different grind angles, grinding wheel wear, etc. The inability to properly set up the jig 10 results in grinding the cutting edge of the chisel 58 at an inconsistent angle. Grinding the cutting edge of the chisel 58 at an inconsistent angle results in lengthy sharpening times and excessive heating of the chisel, removal of excessive material from the chisel, and a change in the chisel performance due to a change in the sharpening angle. As is shown, the chisel tip 58a contacts the grinding wheel 26 up above the center of the wheel, increasing the difficulty in properly setting up the support arm 34 accurately.

While people currently attempt to set the distance between the grinding wheel 26 and the cup 38 with a tape measure or the like, this is inaccurate and quite difficult to do since the desired setup is not simply the distance between the wheel and the cup. The desired setup of the support arm and cup 38 involves both the combined distance and angular relationship between the wheel and the cup. Thus, users currently can not accurately set up the grinding jig 10.

There is a need for a manner for accurately and repeatably setting up a grinding jig so that chisels 58 are consistently sharpened at the desired angle. There is a need for an easy way to set up a grinding jig so that users may quickly sharpen chisels without sacrificing accuracy.

### SUMMARY OF THE INVENTION

It is an object of the present invention to provide an improved tool for use in setting up a sharpening jig for chisels.

According to one aspect of the invention, a tool is provided which easily sets the support arm of a sharpening jig at the proper distance to achieve a desired chisel sharpening angle. The tool will establish the proper grind angle for grinding wheels of different diameters, and thus remains accurate even as the grinding wheel wears.

These and other aspects of the present invention are realized in a sharpening jig setup tool as shown and described in the following figures and related description.

### BRIEF DESCRIPTION OF THE DRAWINGS

Various embodiments of the present invention are shown and described in reference to the numbered drawings wherein:

FIG. 1 shows a side view of a prior art sharpening jig;

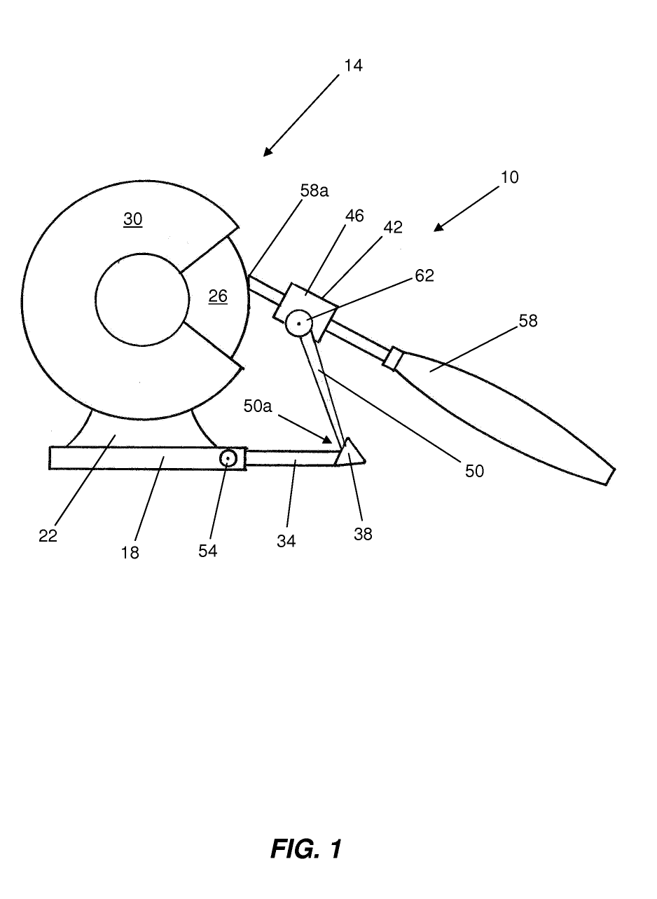

FIG. 2 shows a setup tool for the jig of FIG. 1;

FIG. 3 shows the setup tool of FIG. 2 in use;

FIG. 4 shows sharpening a chisel after using the setup tool of FIG. 2;

FIG. 5 shows the setup tool of FIG. 2 in an alternate use; and

FIG. 6 shows two setup tools of FIG. 2 overlaid to show tools for the setup of different chisel grind angles.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Several aspects from different figures may be used in accordance with the present invention in a single structure. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

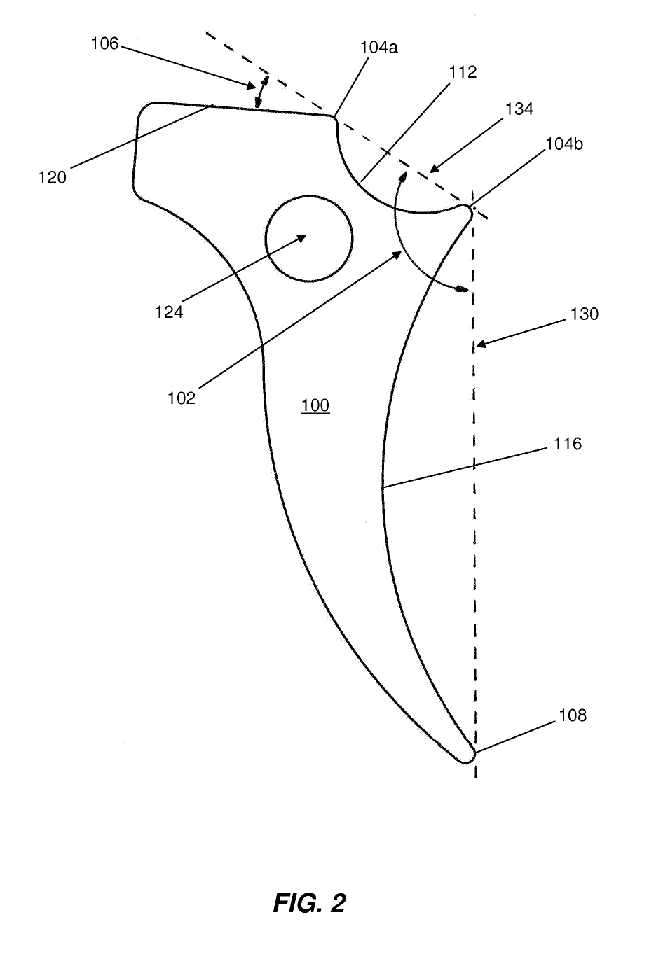

Turning now to FIG. 2, a side view of a setup tool 100 of the present invention is shown. The setup tool 100 includes two grinding wheel contact points 104 which contact a grinding wheel 26 and an arm contact point 108 which contacts the cup 38 of the adjustable arm 34 of a tool grinding jig. These three contact points 104, 108 establish the functionality of the tool 100. The grinding wheel contact points 104 are connected by a concave edge 112, allowing the radius of a grinding wheel to extend past the points 104. The second grinding wheel contact point 104b is connected to the arm contact point 108 by a concave edge 116, avoiding interference with a grinder guard 30 or other devices. The angle 102 formed by points 104a, 104b, and 108 as well as the distances between these points sets the angle of a grinding jig as discussed. The first grinding wheel contact point 104a is adjacent a flat edge 120 which may be used to set the angle of a conventional grinder tool rest. The angle 106 between the flat edge 120 and the line 134 connecting points 104a and 104b sets the tool rest angle. The angles 102 and 106 are not the same as the desired sharpening angle, since the curvature of the grinding wheel and the distances between points 104a, 104b and 108 affect the grind angle. A hole 124 may be provided to make it easier to grip the tool 100.

The tool 100 is shaped to provide a desired angular and dimensional relationship between the arm contact point 108 and the grinding wheel contact points 104. The angular relationship of the arm contact point 108 and the grinding wheel contact points 104 determines the distance between the cup 38 of the grinding jig and the grinding wheel 26. The tool 100 is formed such that the grinding wheel contact points 104 contact the grinding wheel 26 near the midpoint of the grinding wheel vertically, even though a cutting tool 58 is sharpened above the centerline of the grinding wheel. It is easier and more accurate to set the support arm 34 and cup 38 at the proper relationship to the grinding wheel where the tool 100 does not contact the grinding wheel at a steep angle above the midpoint of the wheel, even though this is where the chisel 58 contacts the grinding wheel 26 for sharpening.

According to a preferred embodiment of the invention, different versions the tool 100 are made to set up a grinding jig to grind different angles into a chisel. Preferably, the chisel is ground to angles of 35, 40, 45, 50 and 60 degrees and different tools 100 are provided to set a grinding jig to grind these angles. For grinding jigs commercially available, the setup tool 100 is formed with the grinding wheel contact points 104a and 104b about 2.125 inches apart from each other. The distance between point 104b and 108 and angles 102 and 106 vary according to the grind angle as shown in Table 1.

TABLE 1

| | | Distance 130 between | |
|---|---|---|---|
| Chisel Grind Angle | Angle 102 | points 104b and 108 | Angle 106 |
| 35 | 125 | 6.88 | 28 |
| 40 | 125 | 7.08 | 30 |
| 45 | 123 | 7.38 | 34 |
| 50 | 123 | 7.82 | 38 |
| 60 | 123 | 8.13 | 46 |

It is seen how the distance between the support arm contact point 108 and the grinding wheel contact point 104b varies while angle 102 does not vary significantly in order to thereby vary the chisel grind angle. The angle 106 between the flat edge 120 and a line 134 between the first and second grinding wheel contact points 104 ranges between about 28 and 46 degrees to set up a conventional grinding wheel tool rest 146 to grind a chisel at an angle between 35 and 60 degrees. Thus, the set tool angles 102 and 106 do not match the desired grind angle, but result in the desired grind angle when used with a conventional tool rest or available grinding jigs.

The tool 100 is used in combination with a tool holder 42 that has a mounting block 46 which is fixed at a set angle relative to the support post 50. This angle is preferably 23 degrees and remains unchanged for sharpening all chisels 58, regardless of the sharpening angle of the chisel cutting edge. The chisel 58 is clamped into the mounting block 46 such that the cutting edge 58a extends a predetermined amount from the mounting block 46, such as 2 inches for an 8 inch grinding wheel 26 or 1.75 inches for a 6 inch grinding wheel. The overhang of the chisel cutting edge 58a is easily set with a reference block having a hole or slot formed therein.

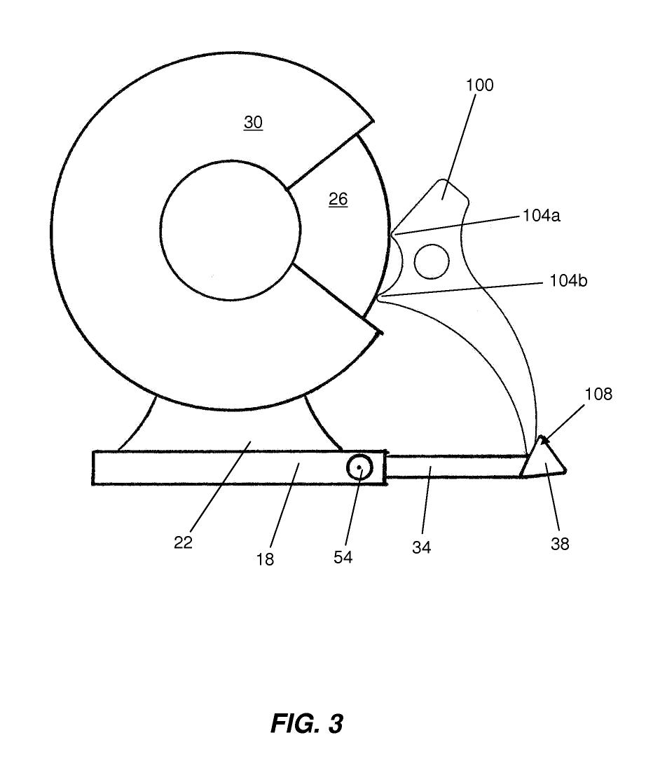

The tool 100 is used to establish the proper distance and angular relationship between the grinding wheel 26 and the cup 38 of the support arm 34 in order to sharpen a chisel 58 which is mounted in a tool holder 42 of a fixed size and angular relationship. The tool 100 thus eliminates the difficulty of adjusting the angle of the tool mounting block 46. In order to establish the distance and angle between the grinding wheel 26 and the cup 38, the grinding wheel contact points 104 are placed against a grinding wheel 26 and the extendible support arm portion 34 is moved to place the contact point 108 in the cup 38, as shown in FIG. 3.

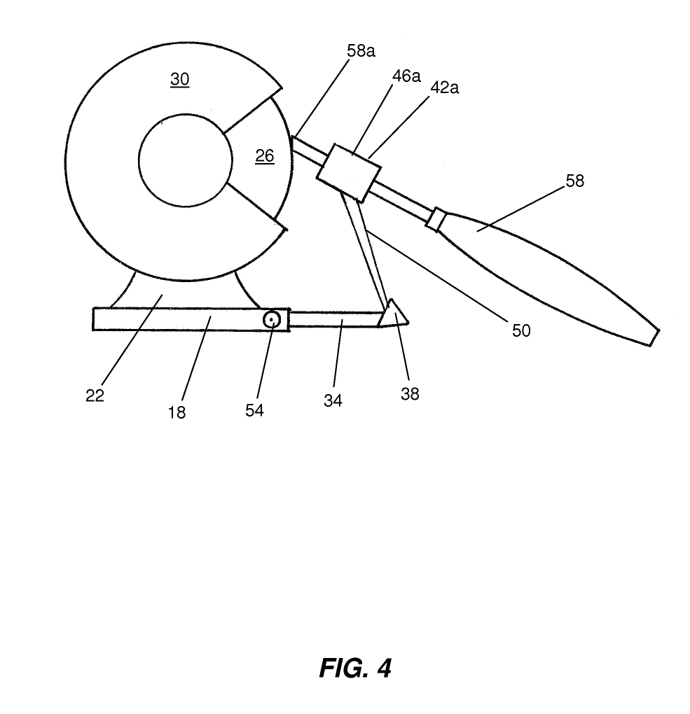

FIG. 4 shows a fixed angle tool holder 42a used after using the setup tool 100. As discussed, the set up tool 100 allows the user to adjust only the location of the cup 38 and support arm 34 and eliminates the need to adjust the angle of the tool holder 42. The tool holder 42 a has a tool mounting block 46a which is mounted to a support post 50 at a fixed angle which is not adjusted by a user to accommodate different grind angles on a chisel 58.

As discussed with respect to FIG. 2, the distance and angular relationship between the cup 38 and the face of the wheel 26 is established by the tool 100, and is determined by the angle and the distance between the arm contact point 108 and the grinding wheel contact points 104. This ensures consistency in setting the support arm 34 and thus ensures consistency in the angle at which the chisel tip 58a is presented to the grinding wheel 26. The remaining variables including the distance by which the chisel tip 58a protrudes from the tool mounting block 46a and the angle between the tool mounting block 46a and the tool support post 50 are maintained constant. As a result, chisels 58 may be accurately and easily sharpened at the same desired angle each time. The tool 100 is able to accurately and repeatably set up the sharpening jig 10 for various differing diameters of grinding wheels 26 by providing the proper distance and angular relationship between the cup 38 and the grinding wheel 26. The tool 100 thus remains accurate and useful as the grinding wheel wears or as different grinders or grinding wheels are used.

As a grinding wheel 26 wears, the sharpening angle for the chisel 58 may change by a small amount, typically a degree or less. This change in sharpening angle, however, is quite small and happens gradually as the grinding wheel 26 wears. As such, this minute change in chisel sharpening angle does not result in a change in tool performance or excessive tool wear. The tool 100 eliminates changes in chisel performance due to inconsistent sharpening and prevents the removal of too much of the chisel due to inconsistent sharpening.

Using lathe gouges for wood turning as an example, gouges sharpened at a shallow angle such as at 40 degrees (i.e. a sharper point) are useful for turning spindles and for detail turning. They do not work well for turning the inside of bowls, however, as the tool shape largely prevents the user from maintaining the bevel of the tool against the work piece and thus prevents the gouge from properly cutting the wood. A gouge which is sharpened at a blunter angle such as 50 degrees works well for turning the interior of bowls as the gouge bevel can be maintained against the surface of the bowl while allowing the gouge to be held at a comfortable and controllable angle by the user. It is thus appreciated how a relatively small change in the angle at which a lathe gouge is sharpened can have a dramatic affect on the performance and appropriate use of the gouge. The difficulty in controlling the sharpening angle of the prior art sharpening systems often keeps a woodturner from appropriately sharpening and using their chisels.

Beyond the poor performance and increased difficulty of use which may occur with improperly sharpened tools, the inability to precisely control the angle at which a tool is sharpened results in excessive grinding and tool consumption when sharpening. When a person desires to sharpen a chisel, a very light sharpening is usually all that is required. If the sharpening angle is correctly set, it is often necessary to remove only a few thousandths of an inch. If the sharpening angle is off by about 5 degrees, however, it will be necessary to grind several hundredths of an inch. This is an issue for several reasons. Where it is necessary to remove several hundredths of an inch of tool material, sharpening the tool twenty or thirty times will remove an inch of the overall tool length. A reduction in tool length reduces the useful life of the tool but also reduces the leverage and control that a user has while using the tool. In contrast, sharpening the tool at the correct angle twenty to thirty times will only remove about one eighth of an inch of the tool.

In addition to excessively consuming the tool and reducing tool life, excessive grinding during sharpening will reduce the life of the grinding wheel and cause additional heat to be generated in the tool. Good grinding wheels are expensive, and it is not desirable to waste the grinding wheel. Heat buildup in the tool can degrade the mechanical properties of the tool steel. Another problem caused by sharpening a tool at the incorrect angle is the effort required by the user. It will take significantly longer to sharpen a tool when more material must be removed, and tool sharpening becomes burdensome to the user. Moreover, it becomes more difficult to maintain the shape of the tool edge while grinding since gouges and other chisels are often ground to a curved edge. If the tool is ground to a different shape, the performance and use of the tool changes. It can thus be seen how the inability to accurately control the grind angle when sharpening a chisel can cause significant problems.

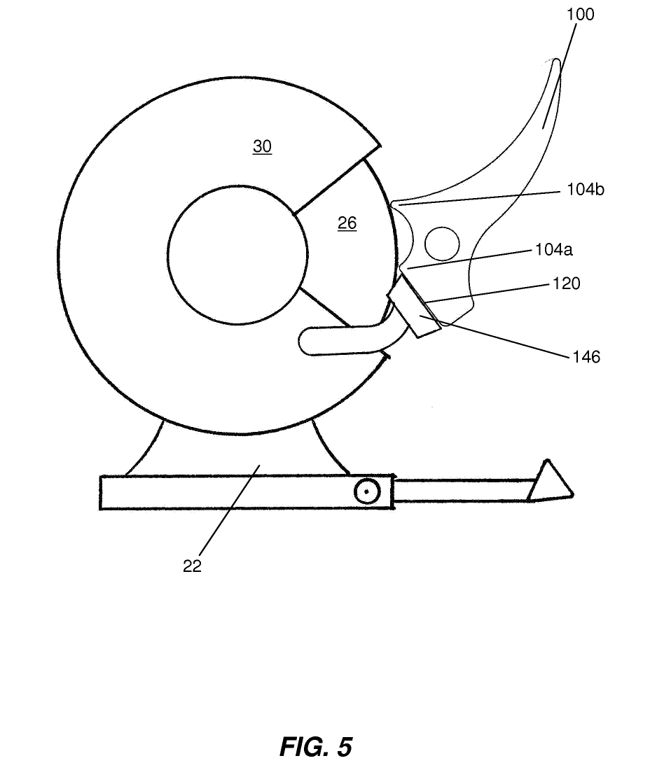

Turning now to FIG. 5, an alternate use of the tool 100 is shown. As mentioned, the tool 100 may be provided with a flat side 120 adjacent grinding wheel contact point 104b. The tool 100 may be used to quickly and easily set the standard grinder tool rest 146 at a desired angle. The tool 100 is shaped such that setting the tool rest 146 as shown will result in the same cutting edge grind angle as when setting up the sharpening jig 10 as shown in FIGS. 3 and 4. This is useful as some chisels, such as wood turning skews or scrapers, will be easier to grind on the tool rest 146 while gouges are more easily sharpened with a sharpening jig 10 as shown in FIG. 4. Thus, the tool 100 provides for consistent sharpening of nearly all types of woodworking chisels.

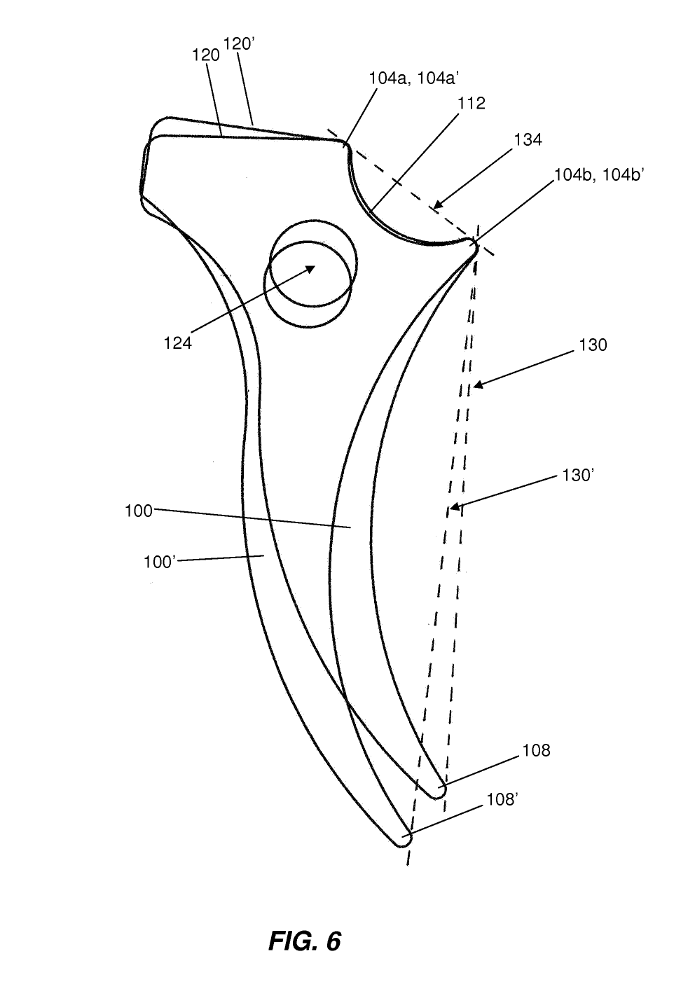

Turning now to FIG. 6, overlaid images of the tool 100 of FIG. 2 and another similar tool 100′. Tool 100′ is shaped to set up a different grind angle than tool 100. Thus, it is observed that point 108′ is in a different location than point 108 so that a different angular and dimensional relationship is formed between point 108′ and points 104′ as compared to point 108 and points 104. Thus, tools 100 and 100′ will set up a sharpening jig to grind different angles into a chisel. Thus, a set of tools 100 will typically be provided wherein each particular tool is shaped to set up a sharpening jig 10 to form a different predetermined grind angle into the chisel tip 58a. Typically, the included angle for sharpening a chisel is between 35 and 70 degrees, and more commonly between about 40 and 60 degrees. Thus, a set of tools 100, 100′ are provided to set the support arm 34 for grinding common angles such as 35, 40, 45, 50 and 60 degrees. As is discussed, the chisel grind angle is not the same as the angles 102 and 106, but the chisel grind angle is precisely determined by the locations of points 108 and 104 used in combination with a tool holder 42a of a known size and angle. That is to say that, for a complementary tool holder 42a, the setup tool 100 will accurately and repeatably set up the support arm 34 and cup 38 to grind a desired angle. The tool 100 will both set up a sharpening jig 10 and a conventional tool rest 146 for a consistent chisel grind angle.

There is thus disclosed an improved tool for use in setting the grind angle for sharpening jigs. It will be appreciated that numerous changes may be made to the present invention without departing from the scope of the claims.

What is claimed is:

1. A tool for use in positioning a sharpening jig comprising:
a body;
a first grinding wheel contact point and a second grinding wheel contact point extending from an end of the body and configured for contacting the surface a grinding wheel;
a concave edge extending between the first and second grinding wheel contact points; and
a support arm contact point extending from the body, the support being configured for contacting a support arm located adjacent the base of a grinder and extending forwards beyond the grinding wheel.

2. The tool of claim 1, wherein the first and second grinding wheel contact points and the support arm contact points are coplanar and are not collinear.

3. The tool of claim 1, wherein an angle formed between the support arm contact point and the first and second grinding wheel contact points is about 123 degrees.

4. The tool of claim 1, wherein the tool further comprises a flat edge extending generally from the first grinding wheel contact point, the flat edge disposed at an angle of between about 28 and 46 degrees relative to a line between the first and second grinding wheel contact points.

5. The tool of claim 4, wherein the distance between the first and second grinding wheel contact points is about two inches.

6. The tool of claim 5, wherein the flat edge is about two inches long.

7. The tool of claim 1, wherein the second grinding wheel contact point is disposed at a distance of about two inches from the first grinding wheel contact point, and wherein the support arm contact point is disposed at a distance of between about seven and eight inches from the second grinding wheel contact point.

8. The tool of claim 1, further comprising a concave edge connecting the support arm contact point and the second grinding wheel contact point.

9. A sharpening system comprising the tool of claim 1, and further comprising:
a grinder having a grinding wheel; and
a support arm located beneath the grinding wheel at about the height of the grinder base, the support arm extending forwards horizontally forwards past the front of the grinding wheel, the support arm having a cup formed at an end thereof such that the cup is placed in front of the grinding wheel; and
wherein the tool is placed in the plane of the grinding wheel such that the two grinding wheel contact points contact the grinding wheel and such that the support arm contact point contacts the cup.

10. A sharpening system comprising the tool of claim 1, and further comprising:
a tool holder comprising:
a tool support arm having a first end and a second end;
a tool mounting block, the tool mounting block having a passage therethrough configured for receiving the shaft of a cutting tool, the tool mounting block being attached to the tool support arm so as to hold the cutting tool shaft at a fixed angle relative to the tool support arm.

11. A method for sharpening a chisel comprising:
selecting a grinder having a grinding wheel and having sharpening jig attached thereto, the sharpening jig having:
a support arm having a cup thereon, the support arm being adjacent the base of the grinder and extending beneath the grinding wheel outwardly in front of the grinding wheel; and
a tool support post, the tool support post having a first end for contacting the support arm cup and a second end for receiving a chisel;
placing a chisel in a tool support post so that the chisel tip extends therefrom;
selecting a setup tool, the setup tool having first and second grinding wheel contact points for contacting the grinding wheel and a support arm contact point for contacting a cup formed in the support arm;
contacting the setup tool against the grinding wheel and adjusting the support arm such that the grinding wheel contact points contact the grinding wheel and the support arm contact point contacts the support arm;
removing the setup tool; and
placing the first end of the tool support post in the cup and contacting the chisel against the grinding wheel to sharpen the chisel.

12. The method of claim 11, wherein adjusting the support arm comprises adjusting the length of the support arm so as to adjust the position of the cup relative to the front of the grinding wheel.

13. The method of claim 11, wherein the setup tool comprises a concave edge connecting the first grinding wheel contact point and the second grinding wheel contact point.

14. The method of claim 11, wherein the setup tool first and second grinding wheel contact points and support arm contact point are located in a single plane.

15. The method of claim 11, wherein the first grinding wheel contact point is located about two inches from the second grinding wheel contact point, and wherein the support arm contact point is located between about seven and eight inches from the second grinding wheel contact point.

16. The method of claim 15, wherein an angle formed by the support arm contact point and the first and second grinding wheel contact points is about 123 degrees.

17. The method of claim 16, wherein the tool support post holds a chisel at a fixed angle relative to the tool support post.

18. The method of claim 17, wherein the fixed angle is about 23 degrees.
